(19) United States
(12) Patent Application Publication
(10) Pub. No.: US 2016/0337902 A1
(43) Pub. Date: Nov. 17, 2016

(54) CELL LOAD BASED CONTENT DATA NETWORK SELECTION

(71) Applicant: NOKIA SOLUTIONS AND NETWORKS GMBH & CO. KG, Munich (DE)

(72) Inventors: Wolfgang HAHN, Bergfelde (DE); Uwe RAUSCHENBACH, Poing (DE)

(21) Appl. No.: 15/105,830

(22) PCT Filed: Dec. 17, 2013
(86) PCT No.: PCT/EP2013/076794

§ 371 Date: Jun. 17, 2016

(51) Int. Cl. H04W 28/08; H04L 29/08; H04L 29/12

(52) U.S. Cl. CPC H04W 28/08; H04L 61/1511; H04L 67/02; H04W 84/12

(57) ABSTRACT

It is provided a method, comprising monitoring a request received from a terminal device, wherein the request requests one of a first address of a first source of at least one file and the at least one file from the first source with the first address; determining a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks; providing, in response to the request, the second address to the terminal device.

### FIELD OF THE INVENTION

The present invention relates to an apparatus, a method, and a computer program product related to radio communication networks. More particularly, the present invention relates to an apparatus, a method, and a computer program product related to traffic offloading.

### BACKGROUND OF THE INVENTION

### Abbreviations

3GPP 3^{rd} Generation Partnership Project
ANDSF Access Network Discovery and Selection Function
AP Access Point (BS in WiFi networks)
BS Base station
CDN Content Delivery Network
DHCP Dynamic Host Configuration Protocol
DNS Domain Name Service
eNB eNodeB, E-UTRAN node B, BS in LTE
GW Gateway, e.g. S/P-GW
HTTP Hypertext Transfer Protocol
IETF Internet Engineering Task Force
i/f Interface
IP Internet Protocol
ISP Internet Service Provider
ISRP Inter System Routing Policy
LTE Long-Term Evolution
MAPCON Multiple Access PDN Connection
MME Mobility Management Entity
MNO Mobile Network Operator
NRPSF Network Routing Policy Server Function
OAM Operation Administration and Management System
PCRF Policy and charging rules function
PDF Portable Document Format
PDN Packet Data Network
P-GW/PGW PDN Gateway
PLMN Public Land Mobile Network
RACS Resource and Admission Control Subsystem
RAN Radio Access Network
Rel Release
RFC Request for Comments
SGW/S-GW Serving GW
TCP Transmission Control Protocol
TR Technical Report
TTL Time to live
UE User Equipment
UP User Plane
UPCON RAN User Plane Congestion Management
URL Uniform Resource Locator
UL Uplink
WG Working Group
WiFi Wireless Fidelity, synonym for WLAN
WLAN Wireless LAN (local area network)

The offloading of cellular data traffic to WiFi networks is currently of very high interest to mobile network operators. Operators are looking for ways to enable efficient and effective WLAN-3GPP network load balancing in order to increase system capacity, system utilization and improve the user experience. This operator interest has led to a specific new study item in 3GPP Radio Access Network working group 2 (3GPP RAN2) to investigate better mechanisms for WLAN/3GPP interworking that take dynamically changing cell load level into account in network selection.

Furthermore, 3GPP is working on a solution to make the network aware of cell congestion situations, and to enable it to react with traffic management actions (UPCON).

Recently, at Mobile World Congress 2013 (MWC 2013), Nokia Siemens Networks® (since August 2013: Nokia Solutions and Networks™) (NSN®) launched “Liquid Applications”. This provides a new Radio Applications Cloud Server (RACS), which is integrated with NSN's Flexi BTS. It leverages IBM's WebSphere Application Service Platform for Networks (ASPN) platform to provide a “standards-based cloud runtime environment” that enables localized processing, content storage, and access to real-time radio and network information in the base station. This technology can be used for several approaches. One application is to provide content nearer to the customer with local caches and other CDN functions. In MWC 2013, video optimization depending on cell load status was presented.

For traffic steering between different access networks several mechanisms are known to provide the routing information to the connection manager in the UE. These are e.g.:
1. ANDSF based policies that are downloaded by the operator to the UE via i/f-4 and can be used to select between 3GPP and different other access networks (such as WLAN) depending on various conditions. This is a 3GPP specific solution.
2. IP stack implemented routing policies working on “Internet layer”: These are IETF defined solutions to route traffic in case of multiple interfaces. This is based on Router Advertisement messages or DHCPv6 extensions for traffic routing information. Source address selection/interface selection with router priorities can be used by the IP stack/connection manager in the UE to select between different interfaces each represented in the UE by a different UE IP address (source address). To implement this, the access router is assigned with a default router priority and/or specific route information is provided (by a DHCP Server) to the UE. Note that the Internet layer solution capabilities may vary between IPv4 and IPv6. See “Towards Network Controlled IP Traffic Offloading”, Communications Magazine, IEEE (Volume: 51, Issue: 3, special issue for Telecommunications Standards).

It should be noted that with the gaining importance of Wi-Fi offload, operators may increasingly make use of these mechanisms for traffic routing for offloading.

In the area of Content Delivery Networks (CDN), various mechanisms have been developed to select the optimal content source for the user (resource selection). Mechanisms used are for example changed URLs (‘URL re-writing”), DNS manipulation or HTTP redirect (this one adds a round trip) for the content re-direction.

### SUMMARY OF THE INVENTION

According to a first aspect of the invention, there is provided an apparatus, comprising monitoring means adapted to monitor a request received from a terminal device, wherein the request requests one of a first address of a first source of at least one file and the at least one file from the first source with the first address; determining means adapted to determine a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks; address providing means adapted to provide, in response to the request, the second address to the terminal device.

In the apparatus, the request may be one of a domain name service request and a hypertext transfer protocol request for the first address.

In the apparatus, the request may be the domain name service request, and the apparatus may further comprise address request forwarding means adapted to forward the request; extracting means adapted to extract the first address from a response received in response to the forwarded request.

In the apparatus, if the request requests the at least one file from the first source, the address providing means may be adapted to provide, to the terminal device, an instruction to request the at least one file from a second source with the second address.

The apparatus may further comprise: checking means adapted to check if the first address and the second address are the same; inhibiting means adapted to inhibit, if the first address and the second address are the same, the address providing means from providing the instruction to the terminal device; and file request forwarding means adapted to forward, if the first address and the second address are the same, the request to the first address.

In the apparatus, the determining means may be further adapted to determine the second address depending on at least one of a type of the at least one file and an application type to be applied to the at least one file.

According to a second aspect of the invention, there is provided an apparatus, comprising detecting means adapted to detect a first address in an address file, wherein the first address indicates a first source of at least one file to be fetched; determining means adapted to determine a second address depending on both the first address and a dynamic status information of at least one of plural access networks, wherein, according to a first stored relationship, the second address is of a second source from which the at least one file to be fetched may be downloaded, and, according to a second stored relationship, each of the first address and the second address is related to a respective one of the plural access networks; modifying means adapted to modify the address file by replacing the first address by the second address.

The apparatus may further comprise: triggering means adapted to trigger the detecting means to detect the first address in the address file if a request for the address file is received from a terminal device; and modification providing means adapted to provide the modified address file to the terminal device in response to the request.

The apparatus may further comprise: address file providing means adapted to provide the address file.

In the apparatus, the address file may be one of a manifest and a hypertext markup language page.

According to a third aspect of the invention, there is provided an apparatus, comprising monitoring means adapted to monitor a request received from a terminal device, wherein the request requests at least one requested address file from a first source with a first address; determining means adapted to determine a second address depending on both the first address and a dynamic status information of at least one of plural access networks, wherein, according to a first stored relationship, the second address is of a second source of the at least one requested address file, and, according to a second stored relationship, each of the first address and the second address is related to a respective one of the plural access networks; fetching means adapted to fetch at least one fetched address file from the second address; providing means adapted to provide, in response to the request, at least one provided address file to the terminal device, wherein the at least one provided address file is based on the at least one fetched address file.

In the apparatus, the at least one address file may comprise at least one of a manifest, a partial manifest, and a hypertext markup language page.

The apparatus according to any of the first to third aspects may further comprise identifying means adapted to identify at least one capability of the terminal device to access a respective one of the plural access networks; wherein the determining means is adapted to determine the second address additionally based on the identified capability.

According to a fourth aspect of the invention, there is provided an apparatus, comprising monitoring processor adapted to monitor a request received from a terminal device, wherein the request requests one of a first address of a first source of at least one file and the at least one file from the first source with the first address; determining processor adapted to determine a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks; address providing processor adapted to provide, in response to the request, the second address to the terminal device.

In the apparatus, the request may be one of a domain name service request and a hypertext transfer protocol request for the first address.

In the apparatus, the request may be the domain name service request, and the apparatus may further comprise address request forwarding processor adapted to forward the request; extracting processor adapted to extract the first address from a response received in response to the forwarded request.

In the apparatus, if the request requests the at least one file from the first source, the address providing processor may be adapted to provide, to the terminal device, an instruction to request the at least one file from a second source with the second address.

The apparatus may further comprise: checking processor adapted to check if the first address and the second address are the same; inhibiting processor adapted to inhibit, if the first address and the second address are the same, the address providing processor from providing the instruction to the terminal device; and file request forwarding processor adapted to forward, if the first address and the second address are the same, the request to the first address.

In the apparatus, the determining processor may be further adapted to determine the second address depending on at least one of a type of the at least one file and an application type to be applied to the at least one file.

According to a fifth aspect of the invention, there is provided an apparatus, comprising detecting processor adapted to detect a first address in an address file, wherein the first address indicates a first source of at least one file to be fetched; determining processor adapted to determine a second address depending on both the first address and a dynamic status information of at least one of plural access networks, wherein, according to a first stored relationship, the second address is of a second source from which the at least one file to be fetched may be downloaded, and, according to a second stored relationship, each of the first address and the second address is related to a respective one of the plural access networks; modifying processor adapted to modify the address file by replacing the first address by the second address.

The apparatus may further comprise: triggering processor adapted to trigger the detecting processor to detect the first address in the address file if a request for the address file is received from a terminal device; and modification providing processor adapted to provide the modified address file to the terminal device in response to the request.

The apparatus may further comprise: address file providing processor adapted to provide the address file.

In the apparatus, the address file may be one of a manifest and a hypertext markup language page.

According to a sixth aspect of the invention, there is provided an apparatus, comprising monitoring processor adapted to monitor a request received from a terminal device, wherein the request requests at least one requested address file from a first source with a first address; determining processor adapted to determine a second address depending on both the first address and a dynamic status information of at least one of plural access networks, wherein, according to a first stored relationship, the second address is of a second source of the at least one requested address file, and, according to a second stored relationship, each of the first address and the second address is related to a respective one of the plural access networks; fetching processor adapted to fetch at least one fetched address file from the second address; providing processor adapted to provide, in response to the request, at least one provided address file to the terminal device, wherein the at least one provided address file is based on the at least one fetched address file.

In the apparatus, the at least one address file may comprise at least one of a manifest, a partial manifest, and a hypertext markup language page.

The apparatus according to any of the fourth to sixth aspects may further comprise identifying processor adapted to identify at least one capability of the terminal device to access a respective one of the plural access networks; wherein the determining processor is adapted to determine the second address additionally based on the identified capability.

In the apparatus according to any of the first to sixth aspects, the dynamic status information may comprise at least one of a load, a failure status, and a link status.

In the apparatus according to any of the first to sixth aspects, the plural access networks may comprise at least a radio network according to a third generation partnership project standard and a wireless local area network or wireless fidelity network.

According to a seventh aspect of the invention, there is provided a method, comprising monitoring a request received from a terminal device, wherein the request requests one of a first address of a first source of at least one file and the at least one file from the first source with the first address; determining a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks; providing, in response to the request, the second address to the terminal device.

In the method, the request may be one of a domain name service request and a hypertext transfer protocol request for the first address.

In the method, the request may be the domain name service request, and the method may further comprise forwarding the request; extracting the first address from a response received in response to the forwarded request.

In the method, if the request requests the at least one file from the first source, the providing of the second address may comprise providing, to the terminal device, an instruction to request the at least one file from a second source with the second address.

The method may further comprise: checking if the first address and the second address are the same; inhibiting, if the first address and the second address are the same, the providing of the instruction to the terminal device; and forwarding, if the first address and the second address are the same, the request to the first address.

In the method, the determining may be further adapted to determine the second address depending on at least one of a type of the at least one file and an application type to be applied to the at least one file.

According to an eighth aspect of the invention, there is provided a method, comprising detecting a first address in an address file, wherein the first address indicates a first source of at least one file to be fetched; determining a second address depending on both the first address and a dynamic status information of at least one of plural access networks, wherein, according to a first stored relationship, the second address is of a second source from which the at least one file to be fetched may be downloaded, and, according to a second stored relationship, each of the first address and the second address is related to a respective one of the plural access networks; modifying the address file by replacing the first address by the second address.

The method may further comprise: triggering the detecting of the first address in the address file if a request for the address file is received from a terminal device; and providing the modified address file to the terminal device in response to the request.

The method may further comprise: providing the address file.

In the method, the address file may be one of a manifest and a hypertext markup language page.

According to a ninth aspect of the invention, there is provided a method, comprising monitoring a request received from a terminal device, wherein the request requests at least one requested address file from a first source with a first address; determining a second address depending on both the first address and a dynamic status information of at least one of plural access networks, wherein, according to a first stored relationship, the second address is of a second source of the at least one requested address file, and, according to a second stored relationship, each of the first address and the second address is related to a respective one of the plural access networks; fetching at least one fetched address file from the second address; providing, in response to the request, at least one provided address file to the terminal device, wherein the at least one provided address file is based on the at least one fetched address file.

In the method, the at least one address file may comprise at least one of a manifest, a partial manifest, and a hypertext markup language page.

The method according to any of the seventh to ninth aspects may further comprise identifying at least one capability of the terminal device to access a respective one of the plural access networks; wherein the determining of the second address may additionally be based on the identified capability.

In the method according to any of the seventh to ninth aspects, the dynamic status information may comprise at least one of a load, a failure status, and a link status.

In the method according to any of the seventh to ninth aspects, the plural access networks may comprise at least a radio network according to a third generation partnership project standard and a wireless local area network or wireless fidelity network.

Each of the methods according to any of the seventh to ninth aspects may be a method of network selection.

According to a tenth aspect of the invention, there is provided a computer program product comprising a set of instructions which, when executed on an apparatus, is configured to cause the apparatus to carry out the method according to any one of the seventh to ninth aspects. The computer program product may be embodied as a computer-readable medium or directly loadable into a computer.

According to some embodiments of the invention, at least one of the following advantages may be achieved:
usage of access networks (e.g. 3GPP and WiFi) is optimized;
network congestion may be reduced or even avoided;
operator has control on what traffic is routed via which access network;
the solution is simple;
it does not require huge computational power;
it is based on existing mechanisms and signaling and, hence, backwards compatible;
the UE need not be modified although it is involved in the processing of the requests;
the solution may be implemented at different locations on the path from UE to CDN;
it may be quickly implemented without waiting for standardization agreement, but it may be standardized, too;
it may be implemented and activated in parts of a RAN network only, making rollout easy, in particular in multi-vendor environment;
it may impact a big portion of the operator's network traffic, e.g. especially video traffic, thus efficiently avoiding/reducing congestion;
the ability of current/future smart phones is used to be simultaneously connected in both cellular and Wi-Fi access;
the issue of mass toggling may not occur. Traffic may be smoothly distributed over the available access systems;
information from CDN routing may be reused in the Network routing policy function to deduce related policies for the ANDSF routing policies and/or for the IP routing based access selection in the access domain (see routers in FIGS. 1 to 3) to advertise their priority to impact UE access network selection. Consequently the solution will add only a limited management effort for the operator.
offloading policies in accordance with CDN routing policies may be implemented: different accesses may have different preferred content resource locations; and
in particular in case of Liquid Applications implementation (or other CDN related enhancements to MNO equipment), the solution may be implemented efficiently as enhancement to a CDN/Cache control implementation.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a system according to an embodiment of the invention;

FIG. 2 shows a system according to an embodiment of the invention;

FIG. 3 shows a system according to an embodiment of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention; and

FIG. 10 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

One objective in WLAN-3GPP offloading is effectively and efficiently making full use of both the 3GPP cellular and WLAN resources within a mobile operator's network. This requires an effective and efficient mechanism for traffic steering between the access technologies based on the current load situation and associated expected user experience.

More in detail, the problem to be solved may be seen as follows: Given an end system (UE) that consumes content from one or more servers, each of the server(s) may be reached by one or more, potentially different, access networks (such as cellular and WiFi). Congestion in one of the networks (e.g. the cellular one) leads to problems with delivering the service. In such case, traffic redirection via the other access network can reduce the load. Embodiments of the invention provide a procedure for such traffic redirection. In some embodiments, the redirection may start already before congestion occurs and, thus, may help to avoid cell congestion.

According to embodiments of the invention, one or more CDN mechanisms used for content source re-selection/re-direction may be used to steer user traffic between different access systems, such as a cellular network and a WiFi network. For that purpose CDN functions located in the operator network are enhanced with functions for access network selection/traffic steering.

An issue is that policies for traffic steering need to be aware of a lot of parameters like Content, Subscriber type, Access Network type, Device, Application, actual congestion, transport and interconnect costs, and numerous other criteria in order to make rational and customer-friendly policy decisions. Thus, traffic steering can easily become a very complex exercise for the network operator.

Embodiments of the invention provide a simple solution that uses existing building blocks (UE based traffic routing according to operator policies, MNO hosted CDN/Caching capabilities, Cell congestion indication from RAN to Core, RACS if available) and provides a mapping of different parameters to a limited number of policies and network configurations.

Current traffic steering methods are often applied to the complete UE traffic (i.e. all the traffic of an UE) or PDN connection, as according to MAPCON (Multiple Access PDN Connection) defined in 3GPP Release 10 specifications. Some proposed traffic steering methods may require new RAN/network based signalling, as currently investigated in RAN WG2 study. Those mechanisms where the RAN broadcasts an offload indication include the danger of mass toggling of UEs between the access systems (e.g. after RAN signals preference for Wi-Fi).

At least some of the embodiments of the invention avoid those drawbacks.

Solutions currently investigated in RAN WG2 for RAN—WiFi interworking require standardization for the RAN—UE interface and the UE behaviour. This leads to a time delay for deployments as first a significant number of UEs need to have the feature implemented. In contrast, embodiments of the present invention are based on features that have been already standardized for the UE side.

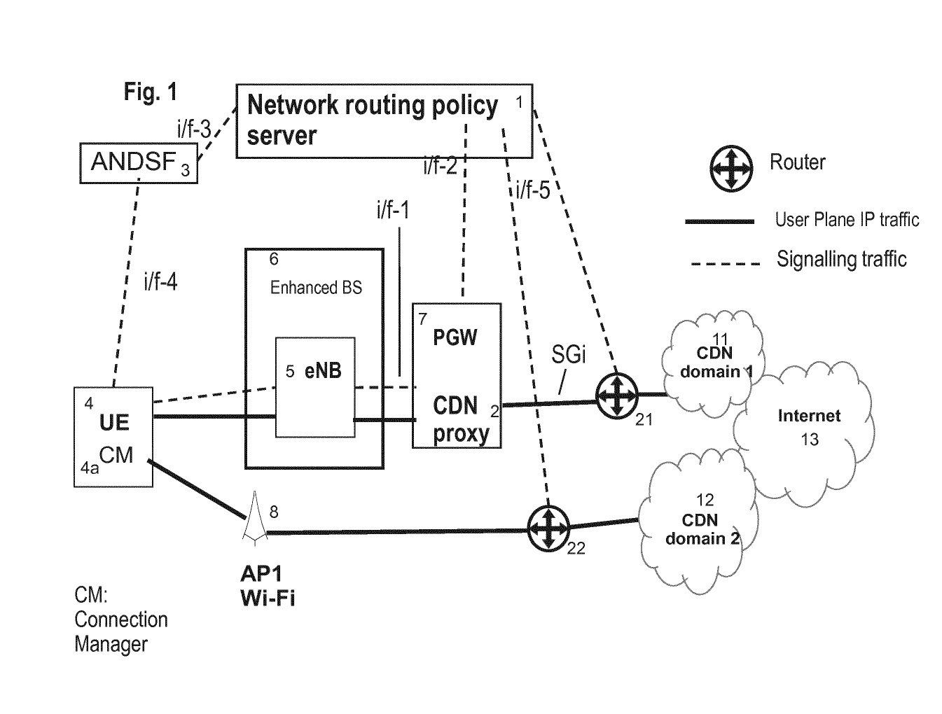

Embodiments of the invention may re-use e.g. ANDSF based policies and/or IP stack implemented routing policies as described above. In FIGS. 1-3, administration of IP stack routing policies in the access router(s) 21, 22 is represented by the i/f-5 between the new introduced “Network Routing Policy Server Function” 1 and a router 21, 22. Both functions (router and NRPSF) may also include a DHCP server. In a 3GPP network, router or DHCP server might reside at the PGW 7. Interface i/f-5 might be implemented as part of the management plane of the router 21, 22 and DHCP server.

Also, other existing mechanism and future coming mechanism for provisioning of the routing information may be used in embodiments of the invention.

Conventionally, the usage of traffic steering policies by the UE takes into account only rather static information like time of day or location but do not react on load status that typically changes more dynamically.

According to embodiments of the invention, an opportunity for finer granular and more dynamic operator controlled traffic steering is added.

The methods to select an optimal source of content are conventionally mainly used to find resources in the proximity of the user (reduced latency and transport costs) or to achieve load balancing among the content servers. They are not used for traffic steering of the UE/host.

An advantage of an RACS such as NSN's “Liquid Applications” is the possibility to make use of the base station's local parameters and status such as the knowledge of cell capacity utilization, especially due to the increasing number of video traffic operators who are interested in CDN solutions to optimize the network. Embodiments of the invention may be applied e.g. to the Liquid Applications solution presented by NSN. E.g., they may enhance the implementation presented at MWC 2013 in several points, in particular by a combination of cache and CDN management with traffic steering. In particular, implementing the below described CDN Proxy on the RACS server may help to reduce the signalling delay of the additional HTTP round trip in case of the HTTP redirect solution to a large extent.

In embodiments of the invention, different content locations may be distinguished by different IP address ranges, called “CDN domains”. CDN domains can contain replicated content, e.g. a mobile network operator may have content sources (CDN domain 1 (11) in FIG. 1) and the network that connects directly to the Wi-Fi access network (CDN domain 2 (12)) can contain a replication of those content sources. The Wi-Fi access network is represented by AP1 8. In other embodiments, one content server may provide both CDN domains, using different network interfaces connected to different IP network domains.

With conventional mechanisms such as those mentioned above, the UEs are provided with IP traffic routing policies that will force the UE to route traffic of e.g. CDN domain 1 to the cellular interface and traffic of CDN domain 2 to the WiFi network interface. As the policies are provided by the operator the operator can control what traffic goes to what access. In the Network Routing Policy Server Function, the operator management of the routing policies according to conventional mechanisms is combined with a function that provides traffic classification and routing policies to the CDN proxy function 2 according to embodiments of the invention. The Network Routing Policy Server Function (NRPSF 1) may have an i/f-3 to the ANDSF 3 to program the ANDSF 3 with the right policies that are downloaded to the UE 4 via i/f-4, and/or it may provide routing information to routers 21, 22 and DHCP servers via i/f-5.

The NRPSF 1 has an administrational function. Preferably, CDN proxy 2, and ANDSF 3 and/or the access router(s) 21, 22 are administered from a central point in order to ensure consistency of the rules provided to these network elements. However, in some embodiments, some or each of the CDN proxy 2, and ANDSF 3 and/or the access router(s) 21, 22 may be separately administered. In such a configuration, operator should ensure consistency of the implemented rules by himself.

An advantageous feature of embodiments of the invention is that the operator can control what content shall be offloaded to Wi-Fi. Furthermore the offloading can be triggered depending on the load status of the cellular network.

Embodiments of the invention may comprise one or more of the following features:
A “CDN proxy function 2” may be included in the user data path. For example, the control function for local caches may be re-used/enhanced for the CDN proxy function 2. The proxy function may reside e.g. in the enhanced BS 6 (in particular as a Liquid Application), in the enhanced GW (PGW) 7, or above the 3GPP PGW 7 (more in detail, in 3GPP terms: above the SGi interface) in the network. These options are respectively shown in FIGS. 1 to 3, wherein same reference numbers denote same or corresponding functions.
The CDN proxy function 2 may monitor relevant content related traffic of the user (e.g. the CDN proxy function 2 monitors DNS requests to predict from which host/domain the UE 4 will fetch content in near future and from what domain). Also, deep packet inspection techniques may be used to predict which HTTP links a UE 4 may follow. This inspection may be applied selectively on pages coming from particular domains 11, 12. The kind of monitoring may depend on the kind of traffic redirection, see below.
The CDN proxy function 2 may receive classification rules that determine what content should be reached via what CDN domain 11, 12. These classes can be mapped e.g. from IP address ranges or application types (e.g. YouTube). The CDN proxy function 2 may receive the classification rules e.g. from a “Network routing policy server function” 1 via i/f-2, or from some administration terminal connected to the CDN proxy function 2.
The CDN proxy function 2 may additionally receive policies on how to react in case of overload situation in the RAN/cell, represented by eNB 5. The basic idea here is to direct the UE 4 to access the content from another CDN domain 11, 12. Thus, the UE may reach the content via a different access network. For instance, controlled by these policies, a UE 4 could prefer CDN domain 2 12 (accessed via Wi-Fi) instead of CDN domain 1 11 (accessed via RAN) for medium value and low value traffic. It is assumed that the CDN proxy 2 has a database (or another data repository) that stores the different content locations and its assignment to the CDN domains 11, 12. The CDN proxy 2 may receive the policies, content locations, and assignments from the “Network routing policy server function” 1 via i/f-2, or from some administrational terminal connected thereto.
In some embodiments, the CDN proxy function 2 may receive classification rules that allow classifying traffic (e.g. high value traffic, medium value traffic, low value traffic). This classification will be used in the policies to define the actions, e.g. start traffic offload (start traffic redirection) at medium congestion level of the cellular network cell with low value traffic classes and offload high value traffic only at high congestion level. These classification rules may be received from the “Network routing policy function” 1 via i/f-2, or from some administrational terminal connected thereto. The classes can be defined e.g. from IP address ranges or application types (e.g. YouTube). With this level of mapping, which is a type of abstraction, the size of information that needs to be transferred on i/f-2 as well as the table size in the CDN proxy function 2 may be reduced.
The policies and rules introduced above may be used to compute a priority (or “favorability index”) for each of the domains w.r.t. a particular piece of content. In case the UE 4 requests a piece of content from a source from the “less favorable” lower priority CDN domain 11, 12 (i.e. according to the classification rules and the policies, wherein another domain for the content is available and has a higher priority than the one the content is requested from), the CDN proxy 2 may start a redirection to a content server located in the “more favorable”, higher priority CDN domain.
For cell load dependent offload the domain priority may be different for different load situations, such that different CDN domains 11, 12 may be “more favorable” depending on the load in one or more of the involved access networks.
The CDN proxy 2 may receive up-to-date cell load information from the RAN to take it into account in the decision on the more (or most) favorable CDN domain 11,12 in case of cell load dependent offload. For this, mechanisms under standardization (the e.g. UPCON study item in 3GPP Rel.12 [TR 23.705]) may be used for uplink signaling of load information from the RAN to the core network. In case of an integration of the CDN proxy 2 in a BS 6 (e.g Liquid Applications RACS server) an internal proprietary interface may be used for this purpose.

Table 1 shows an example of a policy table, indicating the respective highest priority CDN domain (CDNdn, n=1, 2, 3, . . . ) for different RAN cell load statuses and contents. In this example, routing priorities provided to the UE would link CDNd1 and CDNd3 access via RAN, CDNd2 and CDNd4 access via WiFi interface.

TABLE 1
Example of a part of a CDN proxy redirection policy table

| | RAN cell load status | | |
|---|---|---|---|
| Content | 0-70% | 70%-90% | >90% |
| YouTube | CDNd1 | CDNd2 | CDNd2 |
| Netflix | CDNd3 | CDNd3 | CDNd4 |
| . . . | | | |

Another example shown in Table 2 uses a traffic classification and the CDN proxy comprises two tables (a content classification table shown on top and a redirection policy table shown at the bottom of Table 2):

TABLE 2
Example of a part of a CDN proxy redirection policy table with content
classification

| Content | Classification |
|---|---|
| YouTube | low value |
| Netflix | medium value |
| . . . | |

| | RAN cell load status | | |
|---|---|---|---|
| Class | 0-70% | 70%-90% | >90% |
| Low value | CDNd1 | CDNd2 | CDNd2 |
| Medium value | VerCDNd1 | CDNd1 | CDNd2 |
| High value | CDNd1 | CDNd1 | CDNd1 |

The operator may try to cache a significant amount of content in the Core or RAN to avoid interconnection cost with other networks providers/ISPs. Such content may be considered as low- or medium value content, i.e. access to it can be redirected if there is congestion in the default access network (e.g. 3GPP network).

The network operator may also provide content via its own content servers, e.g. to take advantage of business opportunities from acting as content provider. From this point of view, operator content could be classified as “high value content” that should be delivered via own network resources and not redirected. Those servers might be located in a CDN-domain1 11 that is provided by a dedicated IP sub-network/IP address range and accessed via RAN.

With this arrangement, the access network and interface selection in the UE 4 can be steered by the operator by using existing mechanisms 1 and 2 mentioned in the prior art section.

In embodiments of the invention, the UE 4 may be provided with policies for intersystem routing (ISRP 1 in case of ANDSF 3), such that, for example, for traffic of CDN domain1 11 the interface to 3GPP network has highest priority, and for other CDN domains (e.g. 12) the WLAN interface has highest priority.

If in case of congestion of the 3GPP network the CDN proxy 2 will redirect the traffic from CDN domain1 11 to CDN domain 2 12, the UE 4 may automatically also redirect the traffic to the WLAN interface if the policies stored in the UE 4 require this. With this mechanism, the offload amount can be nicely adapted to the cell load status, and high load situations may be proactively avoided if the redirection will already start with cell load levels below overload.

FIG. 1 shows a system according to an embodiment of the invention. In particular, it shows the nodes, functions and interfaces for a GW based implementation. Note that the 3GPP architecture is not completely depicted, e.g. SGW is missing. Also, the system shows the relevant parts of a logical architecture, wherein the physical architecture may be different from the logical architecture.

The UE 4 with its connection manager CM 4a is connected to both the 3GPP network (via eNB 5) and the WiFi network (via AP 4) as access networks. These access networks are connected via respective routers 21, 22 and PGW 7 (for the 3GPP network) to CDN domain 1 11 and CDN domain 2 12, respectively. CDN proxy 2 is integrated with PGW 7.

The network routing policy server 1 provides policies and rules to ANDSF 3 via i/f-3, routers 21, 22 via i/f-5, and CDN proxy 2 via i/f-2. ANDSF 3 provides the policies to UE 4 via i/f-4.

eNB 5 knows about its load status. To transfer the load status between the eNB 5 and CDN proxy 2 on i/f-1, e.g. a mechanism under development in the 3GPP UPCON work item to transfer the load status between eNB 5 and P-GW 7 may be used. This i/f-1 signalling might involve other network elements not shown in the picture like SGW or PCRF and MME.

FIG. 2 corresponds to FIG. 1 except that CDN proxy 2 is combined with eNB 5 instead of P-GW 7 to form an Enhanced BS 6. The Enhanced BS 6 connects via the SGW and PGW 7 (depicted as GW1) to the operator network and internet 13. If CDN proxy 2 is combined with eNB 5, an internal (proprietary) interface i/f-1 may be used to transfer the load status between the BS 6 and the CDN proxy 2. This solution can take advantage of an integrated CDN function 2 in the eNB 5 like a cache that will intercept the user content for traffic redirection to its own content sources.

For example, FIG. 2 may show an implementation with Liquid Applications Server in the BS for CDN processing and RAN cell load based content redirection.

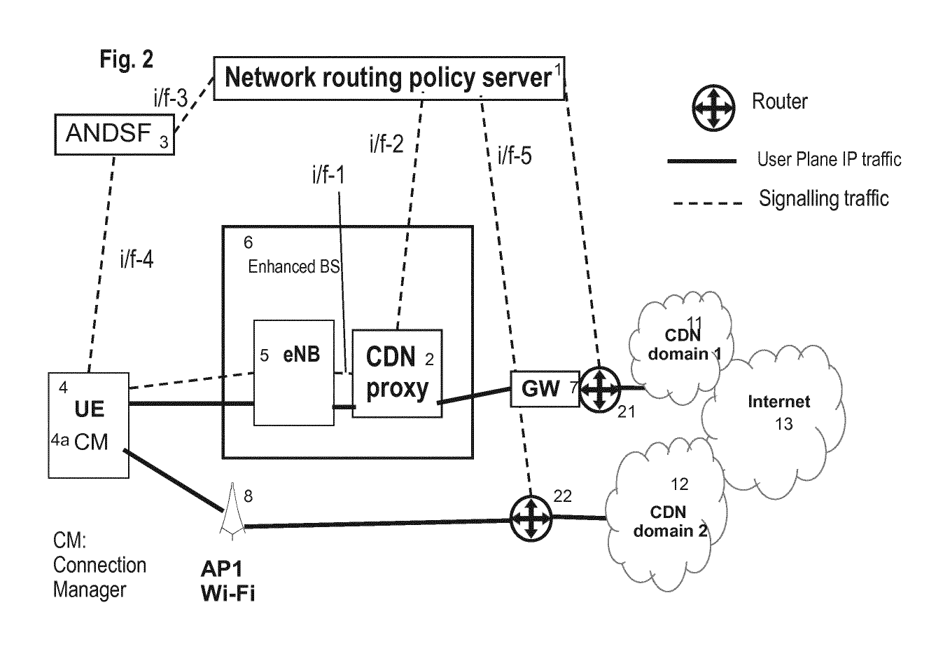

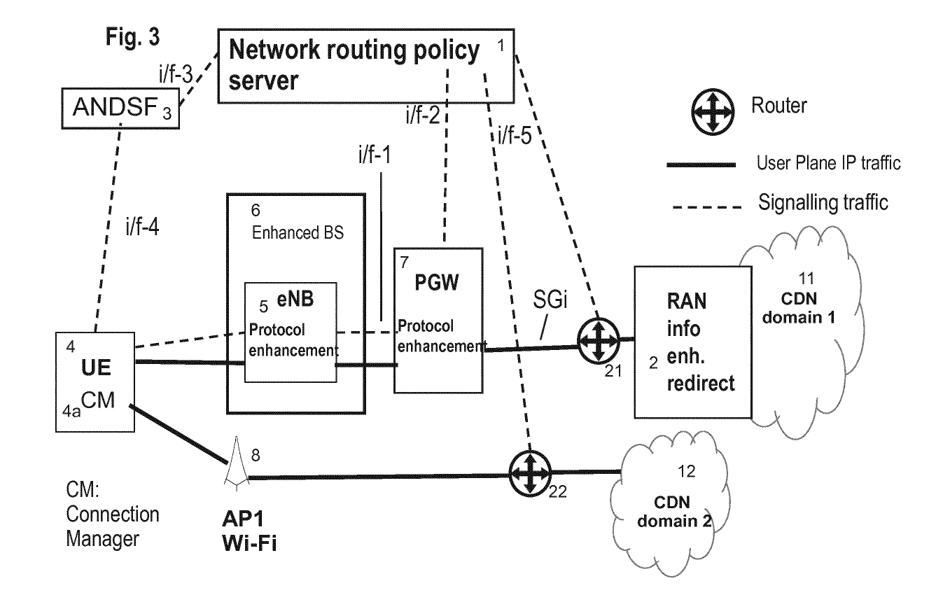

In another implementation shown in FIG. 3, the CDN network itself may take care about the traffic redirection according to the RAN status (load etc.). For this, the 3GPP network may include the load status into the CDN relevant protocols (TCP, DNS, HTTP). Alternatively, this function may be implemented in the eNB 5 or PGW 7.

The CDN proxy may apply one or more of the following redirection options:
1) DNS manipulation: The CDN server delivering a piece of content may be replicated in another CDN domain, such that original and replica are located in different (sub)networks, or the CDN server may have two network interfaces mapped into different (sub)networks. Each (sub)network may be reachable by a different route from the UE which may include the use of different access technologies. To redirect, the DNS server may be manipulated in such a way that it responds to DNS requests with different IP addresses of the server, depending on parameters such as load on the RAN and/or value of the traffic. The DNS server may be part of the CDN proxy or controlled by the CDN proxy or the DNS messages may be manipulated by the CDN proxy. Note that when using DNS manipulation, the DNS server should ensure that the response to the DNS-Query is marked as not being cacheable by setting the TTL field to zero.
2) Manifest manipulation for HTTP Streaming: In case of http-based streaming, a video is split into sequential chunks, each covering a certain part, often a few seconds, of the total duration of the video. Usually, several versions of each chunk are created, to cater to different bit rates and/or different codecs. The chunks are declared in a manifest that needs to be downloaded by the client at the beginning of the streaming session, and may be updated in-session. A manifest may be either complete (i.e. it defines all chunks of a particular video essence) or partial (i.e. it only defines a part of all chunks). Currently, a partial manifest is the only possibility to do live streaming based on HTTP, since at the time of downloading the manifest, not all chunks of a video are known.
Partial manifests need to be updated—at certain times, metadata describing one or more additional video chunks will be appended to the manifest. Such updated manifest is downloaded by the client per HTTP request shortly before it runs out of data. These updates may be modified by the CDN proxy in order to instruct the client on the UE to load a particular chunk from a different server (in combination with a suitable set-up of the routing, this will ensure that the content is retrieved via a different network interface). Note that the effect of the re-routing is not immediate because it can only occur at those points in time when the manifest is updated.
In some embodiments, CDN proxy may proactively modify the manifest such that it comprises an address related to an appropriate network in view of the dynamic status information. In these embodiments, a modification of the (modified) manifest at the time of download may not be needed. For example, CDN proxy may keep a list of modified manifests. The list may also include a time of the modification and/or a validity indication. If a manifest out of this list is downloaded, CDN proxy may not check if an address comprised in the manifest is to be modified.
3) HTTP redirect or DNS manipulation for HTTP streaming: HTTP streaming may also be combined with HTTP redirect and DNS manipulation to instruct the terminal to fetch a manifest, an update of a partial manifest or a video chunk from a different CDN domain. This option allows a fine-granular offload control. Clients starting a video playback in a congested network can have their initial manifest request redirected to a manifest in another CDN domain that declares video chunks in that domain, using HTTP redirect or DNS manipulation. Clients that have a video playback ongoing can have their manifest update download request redirected to an updated partial manifest in another CDN domain, using HTTP redirect or DNS manipulation. Even clients that are in the middle of a streaming session based on a complete manifest can have their download request for the next video chunk redirected to a copy of that chunk in another CDN domain, using HTTP redirect or DNS manipulation.
4) URL rewriting: This technique is widely used in CDNs and is essentially at the same level as manifest manipulation, however, it may be more challenging. It comprises parsing HTML pages, finding URLs that point to content for which a redirection should take place, and modifying these in the HTML code.
As discussed for manifest manipulation, manipulating HTML pages may be performed when the HTML page is requested by a HTTP request, or proactively, without a request for the respective HTML page. Correspondingly, CDN proxy may not check the addresses comprised in modified HTML pages.
Since URLs may be computed using JavaScript, URL rewriting as given here might be complex for modern web sites. In order to avoid such complex task, one may alternatively use a proxy technique as defined below.
5) Response-modifying proxy: CDN proxy may act as a (transparent or non-transparent) HTTP proxy modifying the responses to HTTP requests. In the present context, rewriting in the HTTP request means that the HTML page is retrieved by the proxy from another location, and served to the originator of the request. The HTML page at the other location may comprise corresponding same or different URLs than those of the originally requested HTML page. According to this option, HTML parsing is not needed.
Note that this option can also be applied to manifests in HTTP streaming. Also, if CDN proxy acts proactively on HTML pages and/or manifests, it may store the modified HTML pages and/or manifests at a different location such that CDN proxy prepares the acting of the response-modifying proxy as discussed above.

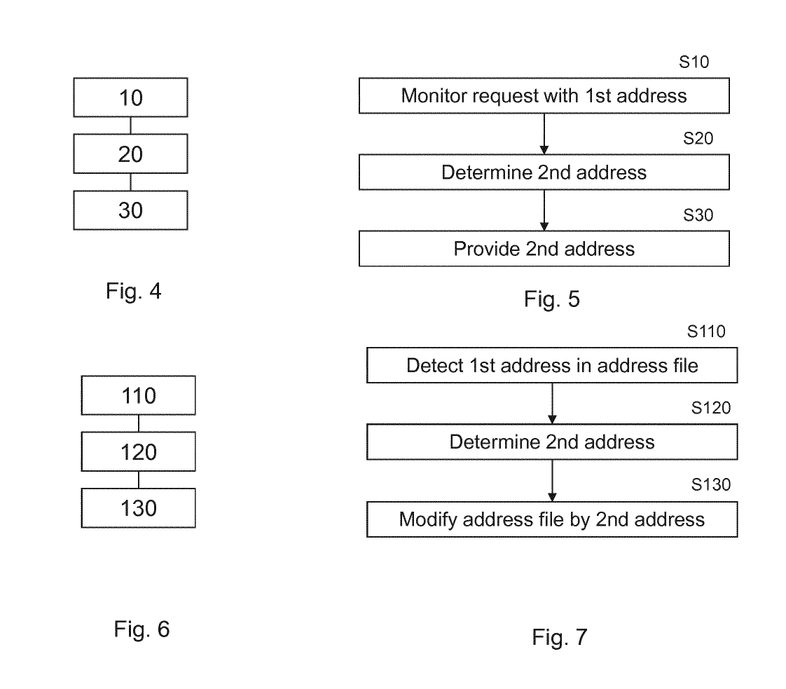

FIG. 4 shows an apparatus according to an embodiment of the invention. The apparatus may be CDN proxy or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises monitoring means 10, determining means 20, and address providing means 30.

The monitoring means 10 monitors a request received from a terminal device (S10). In the request, a first address of a first source of a file may be requested and/or the file from the first source with the first address may be requested. The file may be a video file, an audio file, or any other type of file such as an image file, a PDF file, a word processor file etc.

The determining means 20 determines a second address depending on the first address and a dynamic status information of at least one of plural access networks (S20). According to a first stored relationship, the second address is an address of a second source of the file. According to a second stored relationship, each of the first address and the second address is related to a respective one of the plural access networks. One or both of the first and second relationships may be stored in one or more data repositories which may be stored on the apparatus, or the apparatus may retrieve the one or both of the relationships from one or more external data repositories. The dynamic status information may comprise e.g. one or more of a load, a failure status, and a link status. The second address may be the same as the first address or different from the first address, depending at least on the dynamic status information.

The address providing means 30 provides, in response to the request, the second address to the terminal device (S30).

FIG. 6 shows an apparatus according to an embodiment of the invention. The apparatus may be CDN proxy or an element thereof. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises detecting means 110, determining means 120, and modifying means 130.

The detecting means 110 detects a first address in an address file for a terminal device (S110). The address file may be e.g. a manifest, a partial manifest, or a HTML page comprising the first address. The apparatus may assume that the first address is of a first source from which the terminal device may download at least one content file such as a video or an audio file, or any other type of file such as an image file, a PDF file, a word processor file, etc.

The determining means 120 determines a second address depending on the first address and a dynamic status information of at least one of plural access networks (S120). According to a first stored relationship, the second address is an address of a second source from which the terminal may download the at least one file. According to a second stored relationship, each of the first address and the second address is related to a respective one of the plural access networks. One or both of the first and second relationships may be stored in one or more data repositories which may be stored on the apparatus, or the apparatus may retrieve one or both of the relationships from one or more external data repositories. The dynamic status information may comprise e.g. one or more of a load, a failure status, and a link status. The second address may be the same as the first address or different from the first address, depending at least on the dynamic status information.

The modifying means 130 modifies the address file by replacing the first address by the second address (S130). The modifying means 130 may also be the actual source of the manifest, e.g. in case the network operator is in control of the content or affiliated with the provider.

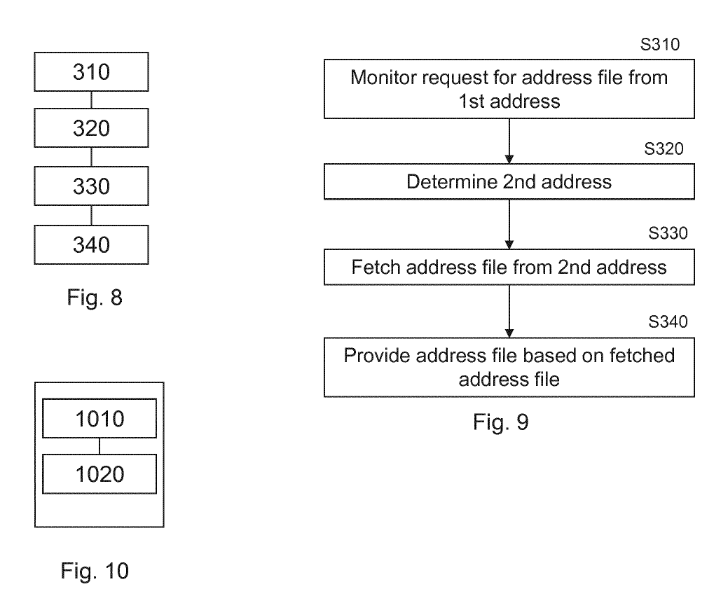

FIG. 8 shows an apparatus according to an embodiment of the invention. The apparatus may be CDN proxy or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises monitoring means 310, determining means 320, fetching means 330, and providing means 340.

The monitoring means 310 monitors a request received from a terminal device, wherein the request requests at least one requested address file from a first source with a first address (S310). The at least one requested address file comprises at least one address. Each of the requested address files may be e.g. a manifest or a partial manifest of HTTP streaming or a HTML page. The apparatus may assume that the first address is of a first source from which the terminal device may download at least one content file such as a video file or an audio file, or any other type of file such as an image file, a PDF file, a word processor file, etc.

The determining means 320 determines a second address depending on the first address and a dynamic status information of at least one of plural access networks (S320). According to a first stored relationship, the second address is an address of a second source of the at least one requested address file. According to a second stored relationship, each of the first address and the second address is related to a respective one of the plural access networks. One or both of the first and second relationships may be stored in one or more data repositories which may be stored on the apparatus, or the apparatus may retrieve the one or both of the relationships from one or more external data repositories. The dynamic status information may comprise e.g. one or more of a load, a failure status, and a link status. The second address may be the same as the first address or different from the first address, depending at least on the dynamic status information.

The fetching means 330 fetches one or more fetched address files from the second address (S330). If properly configured, the fetched address files at the second address may correspond to the address files at the first address which were requested by the terminal device.

The providing means 340 provides, in response to the request, one or more provided address files to the terminal device (S340). The one or more provided address files are based on the one or more fetched address files. In particular, the one or more provided address files may be the same as the one or more fetched address files. However, in some embodiments, the apparatus may modify the fetched address files somehow (e.g. by a format conversion) to obtain the provided files.

An apparatus according to an embodiment of the invention may be adapted to perform one or more of the methods of FIGS. 5, 7, and 9. Thus, an apparatus of an embodiment of the invention may be a combination of one or more of the apparatuses of FIGS. 4, 6, and 8.

FIG. 10 shows an apparatus according to an embodiment of the invention. The apparatus comprises at least one processor 1010, at least one memory 1020 including computer program code, and the at least one processor, with the at least one memory and the computer program code, being arranged to cause the apparatus to at least perform at least one of the methods according to FIGS. 5, 7, and 9.

Embodiments of the invention may be employed in a 3GPP network where offloading (e.g. to a WiFi network) is employed. They may be employed also in other networks with offloading like CDMA, EDGE, UMTS, LTE, LTE-A, WiFi networks, etc. A cell device may be a base station of the corresponding technology, such as a NodeB or eNodeB, or a part thereof serving a cell. It may also be a terminal which acts as a cell device for other terminals. A terminal (terminal device, user equipment) may be a mobile phone, a smart phone, a PDA, a laptop or any other terminal which may be attached to the respective network.

Embodiments of the invention are described, wherein the routing policy depends on the load in an access network. In some embodiments, the load of only one of the networks (e.g. 3GPP network) may be considered. In other embodiments, the loads of plural access networks may be taken into account. E.g., a rule may be to choose always the access network with the lowest relative load. Another rule may be that a first one of the access networks (e.g. 3GPP network) may be used in any case if its load is below a first threshold, and that the other network may be used if the load in the first access network (3GPP network in the above example) is above the first threshold and the load in the other network is below a second threshold.

Embodiments of the invention are described wherein a load is taken into account to decide on the routing policy. In some embodiments, instead or in addition to the load, other dynamic status information of the respective access network(s) may be taken into account such as a failure status of the access network, and/or a link status to the access network (link between UE and access network, and/or link between access network and CDN domain). In general, dynamic status information comprises information of some status of the network which typically cannot be precisely predicted when the network is in operation.

In some embodiments, CDN proxy may be aware of the capabilities of the UE to access a certain network. E.g. it may know whether a certain UE has a WLAN interface. Such information may be derived e.g. from the type of the UE and a pre-stored table showing which type of UE has which capabilities. The UE type may be transmitted to the CDN proxy over the interface i/f-1. If CDN proxy knows that a certain UE does not have the capability to access a certain network (e.g. WLAN), it may exclude this network from the routing decision. It should be noted that the proposed rerouting also works in many cases if the CDN proxy is unaware of the UE capabilities: Both the first and the second address can be accessed from each access interface of the device e.g. over the Internet and this way also in case the device supports only one access network interface. In case the device supports multiple access networks the stored relationship in the device of address with the access system guides the device to use the preferred access network.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on a different software, or some or all of the entities may be based on the same software.

According to the above description, it should thus be apparent that exemplary embodiments of the present invention provide, for example an address modifying device such as a CDN proxy device, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-32. (canceled)

33. Apparatus, comprising
monitoring means adapted to monitor a request received from a terminal device, wherein the request requests one of a first address of a first source of at least one file and the at least one file from the first source with the first address;
determining means adapted to determine a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks;
address providing means adapted to provide, in response to the request, the second address to the terminal device.

34. The apparatus according to claim 33, wherein the request is one of a domain name service request and a hypertext transfer protocol request for the first address.

35. The apparatus according to claim 34, wherein the request is the domain name service request, and the apparatus further comprises
address request forwarding means adapted to forward the request;
extracting means adapted to extract the first address from a response received in response to the forwarded request.

36. The apparatus according to claim 33, wherein,
if the request requests the at least one file from the first source, the address providing means is adapted to provide, to the terminal device, an instruction to request the at least one file from a second source with the second address.

37. The apparatus according to claim 36, further comprising:
checking means adapted to check if the first address and the second address are the same;
inhibiting means adapted to inhibit, if the first address and the second address are the same, the address providing means from providing the instruction to the terminal device; and
file request forwarding means adapted to forward, if the first address and the second address are the same, the request to the first address.

38. The apparatus according to claim 33, wherein the determining means is further adapted to determine the second address depending on at least one of a type of the at least one file and an application type to be applied to the at least one file.

39. Apparatus, comprising
detecting means adapted to detect a first address in an address file, wherein the first address indicates a first source of at least one file to be fetched;
determining means adapted to determine a second address depending on both the first address and a dynamic status information of at least one of plural access networks, wherein, according to a first stored relationship, the second address is of a second source from which the at least one file to be fetched may be downloaded, and, according to a second stored relationship, each of the first address and the second address is related to a respective one of the plural access networks;
modifying means adapted to modify the address file by replacing the first address by the second address.

40. The apparatus according to claim 39, further comprising:
triggering means adapted to trigger the detecting means to detect the first address in the address file if a request for the address file is received from a terminal device; and
modification providing means adapted to provide the modified address file to the terminal device in response to the request.

41. The apparatus according to claim 39, further comprising:
address file providing means adapted to provide the address file.

42. The apparatus according to claim 39, wherein the address file is one of a manifest and a hypertext markup language page.

43. The apparatus according to claim 33, further comprising
identifying means adapted to identify at least one capability of the terminal device to access a respective one of the plural access networks; wherein
the determining means is adapted to determine the second address additionally based on the identified capability.

44. The apparatus according to claim 33, wherein
the dynamic status information comprises at least one of a load, a failure status, and a link status.

45. The apparatus according to claim 33, wherein
the plural access networks comprise at least a radio network according to a third generation partnership project standard and a wireless local area network or wireless fidelity network.

46. Method, comprising
monitoring a request received from a terminal device, wherein the request requests one of a first address of a first source of at least one file and the at least one file from the first source with the first address;
determining a second address depending on both the first address and a dynamic status information of at least one of plural access networks, wherein, according to a first stored relationship, the second address is of a second source of the at least one file, and, according to a second stored relationship, each of the first address and the second address is related to a respective one of the plural access networks;
providing, in response to the request, the second address to the terminal device.

47. The method according to claim 46, wherein the request is one of a domain name service request and a hypertext transfer protocol request for the first address.

48. The method according to claim 47, wherein the request is the domain name service request, and the method further comprises
forwarding the request;
extracting the first address from a response received in response to the forwarded request.

49. The method according to claim 46, wherein,
if the request requests the at least one file from the first source, the providing of the second address comprises providing, to the terminal device, an instruction to request the at least one file from a second source with the second address.

50. The method according to claim 49, further comprising:
checking if the first address and the second address are the same;
inhibiting, if the first address and the second address are the same, the providing of the instruction to the terminal device; and
forwarding, if the first address and the second address are the same, the request to the first address.

51. The method according to claim 46, wherein the determining is further adapted to determine the second address depending on at least one of a type of the at least one file and an application type to be applied to the at least one file.

52. A computer program product embodied on a non-transitory computer-readable medium, said product comprising a set of instructions which, when executed on an apparatus, is configured to cause the apparatus to carry out the method according to claim 46.
